(19) United States
(12) Patent Application Publication
(10) Pub. No.: US 2010/0210807 A1
(43) Pub. Date: Aug. 19, 2010

(54) ELECTROCHROMIC FORMULATIONS AND USES THEREFOR

(76) Inventors: Roland Hehn, Erlangen (DE); Andreas Kanitz, Hochstadt (DE); Wolfgang Roth, Uttenreuth (DE)

Correspondence Address: King & Spalding LLP, 401 Congress Avenue, Suite 3200, Austin, TX, 78701, US

(21) Appl. No.: 12/438,194

(22) PCT Filed: Aug. 16, 2007
(86) PCT No.: PCT/EP07/58546

§ 371 Date: Nov. 11, 2009

(30) Foreign Application Priority Data
Aug. 21, 2006 (DE) 10 2006 039 186.1

(51) Int. Cl. C08G 79/00

(52) U.S. Cl. 528/9

(57) ABSTRACT

In an electrochromically active formulation and the use therefor in electrochromic devices such as displays, windows and mirrors, the electrochromically active formulation exhibits increased long-term stability and improved electrode protection. This is attributable to the use of metallocenes and/or metallocene derivatives in the formulation.

### CROSS-REFERENCE TO RELATED APPLICATIONS

This application is a U.S. National Stage Application of International Application No. PCT/EP2007/058546 filed Aug. 16, 2007, which designates the United States of America, and claims priority to German Patent Application No. 10 2006 039 186.1 filed Aug. 21, 2006. The contents of these applications are incorporated herein in their entirety by this reference.

### TECHNICAL FIELD

The invention relates to displays based on the electrochromic effect, in particular the production and use of electrochromically active formulations with increased long-term stability and improved electrode protection.

### BACKGROUND

Electrochromic displays based on organic materials typically comprise a layer of special composition which, in the case of a display, is situated between electrodes arranged perpendicularly to one another. There exist electrochromic formulations in which the coloring agent is a pH indicator, whilst there are other electrochromic formulations of which an essential component is a redox-active coloring agent. The latter are known, for example, from DE 10 2005 032 316.2, the disclosure of which is herewith also made part of the subject matter of the present description. The coloring agent is typically present in a white pigment matrix dispersed in a solvent. A typical solvent is, for example, diethylene glycol and the white pigment is, for example, titanium dioxide.

A disadvantage of the known systems is their short operating life. In pH value-controlled electrochromic systems (known, for example, from WO 02/075441 A2), the transparent electrodes can become decomposed for example as a consequence of the proton activity. In electrochromic systems based purely on redox materials, as is the case in the so-called viologen-based systems, the worsening in color contrast occurs above all due to the primerization of the reduced species (formation of aromatic stacks by the π-electron levels) which results in a color shift from blue to violet (and it is for that reason they are known as “viologens”) and consequently leads to extremely poor solubility. In this state, the primer species can no longer be completely electrically oxidized (converted to the colorless condition), so that the contrast of the color change becomes ever smaller.

### SUMMARY

According to various embodiments, a formulation for an electrochromic system can be provided which has long-term stability.

According to an embodiment, in an electrochromically active formulation based on polymer 4,4′-bipyridine structures, the polymer 4,4′-bipyridine structures are separated from one another by an alkene spacer comprising at least one metallocene and/or a metallocene derivative.

According to a further embodiment, the metallocene can be iron-based. According to a further embodiment, the derivatization of the metallocene can be carried out via functional groups, so that the polarity, solubility and processing ability of the metallocene derivative is improved compared with the underivatized metallocene basic structure. According to a further embodiment, the metallocene and/or the metallocene derivative can be present as a chain polymer component in the main chain of the polymer or as a component of the side group in the polymer.

According to another embodiment, the formulation can be used for production of an electrochromic device.

According to a further embodiment of the use, the electrochromic device can be a display. According to a further embodiment of the use, the electrochromic device can be a window or a mirror.

### DETAILED DESCRIPTION

The various embodiments are based on the general recognition that metallocenes and metallocene derivatives are suitable for increasing the long-term stability of electrochromically active formulations, firstly because they stabilize the formulation structurally and, secondly, because they protect the electrodes, and particularly the anode.

According to various embodiments, an electrochromically active formulation contains at least one metallocene and/or a metallocene derivative. According to other embodiments metallocene derivatives can be used in electrochromic formulations.

According to an embodiment, the electrochromically active formulation is a formulation based on polymer 4,4′-bipyridine structures, which are separated from one another by an alkene spacer (C10 to C20).

According to an embodiment, metallocene derivatives are used, their polarity being greater compared with the metallocene basic structures and therefore their solubility and processing ability in electrochromically active formulations is improved, so that separation is prevented. As a result, stable layers are obtained, even on large areas, thereby improving application, for example, in roll-to-roll processes.

In particular, ferrocene derivatives with improved solubility/processing ability are utilized.

Preferred metallocene derivatives involve both chain polymers with metallocene units in the main chain and/or side chain polymers with metallocene units as side groups. Production is carried out using known methods in that suitable functional groups are brought into reaction.

For the synthesis of chain polymers, commercially available difunctionalized metallocene derivatives, in particular ferrocene derivatives are suitable as starting components. One such starting component is, for example, 1,1′-ferrocene dicarboxylic acid, the polarity of which is increased compared with the ferrocene basic structure due to the strongly electron-attracting acid groups. If this is reacted, for example, with difunctional reactants of the general structure X—R—X, where R=a hydrocarbon group, aliphatic or aromatic, and X is, for example, —OH, —NH₂ and/or —NCO, chain-form polymers with increased polarity are obtained.

In the case, for example, of 1,1′-ferrocene dicarboxylic acid, this can be reacted with a diol, for example, diethylene glycol. This reaction takes place in a known esterification reaction with carbodiimide as the catalyst, wherein a ferrocene-containing polyester is obtained as the reaction product.

A further possibility for the reaction of 1,1′-ferrocene dicarboxylic acid is its reaction with a difunctional amine, for example, 1,6-hexamethylene diamine. This produces a ferrocene-containing polyamide. In both cases, with the ferrocene-containing polymers obtained, electrochromically active formulations can be produced which no longer exhibit aggregation and separation in an electrochromic formulation based on polymer 4,4′-bipyridine structures. This is due, inter alia, to the greater polarity of the derivatives compared with the ferrocene basic structure.

Although any metallocene derivatives and, in particular, any ferrocene derivatives can be used according to various embodiments, it should be particularly emphasized that derivatives with reduced volatility are suitable for use at raised temperatures. The volatility of the metallocene derivatives is also greatly reduced by derivatization, which leads to an increase in the polarity of the molecule.

Commercially available monofunctionalized ferrocene derivatives are suitable as starting compounds for the synthesis of side-chain polymers. An example of a starting compound of this type is ferrocenyl methanol. This compound is reacted, for example, with a polyacrylic acid ester wherein, as a result of the transesterification, a ferrocene side group is introduced. Through variation of the reaction components, the content of the ferrocene groups can be adapted to the requirements of the electrochromically active formulation. A further example is the reaction of ferrocenyl ethanoic acid with a polyethylene imine. Finally, side chain polyimides can also be produced in which ferrocene is introduced into the side chain. For example, herein maleic imide-styrene copolymers are used as a polymer matrix. Here also, the derivatization with electron-attracting substitutes leads to increased polarity in the resulting molecule.

Further preferred metallocene derivatives are metallocene dimers, which are obtainable from the acylmetallocenes by McMurry coupling.

The invention will now be described in greater detail by reference to selected exemplary embodiments:

1 Synthesis of a Polymer from 1,1′-ferrocene Dicarboxylic Acid and Diethylene Glycol

4 g (14.6 mmol) 1,1′-ferrocene dicarboxylic acid and 1.5 g (14.6 mmol) distilled diethylene glycol was added to 250 ml dichloroethane which had been dried with a molecular sieve.

7.4 g (35 mmol) dicyclohexylcarbodiimide was added to this mixture. The mixture was stirred at room temperature for 48 hours. The reaction mixture was washed with water and, following drying with sodium sulphate, the solvent was drawn off and the residue was absorbed with a little dichloroethane. The polymer precipitated out of the concentrated solution as an orange-colored powder.

### 2 Synthesis of a Ferrocene-Containing Polyimide Copolymer

a)—by copolymerization from maleic anhydride and allyl trimethylsilane and subsequent imidization with 4-hydroxyaniline.

Maleic anhydride was copolymerized with allyl trimethylsilane by initiation with AIBN in ethyl acetate. Following completion of the reaction, the molar quantity of 4-hydroxyaniline is added and the mixture was heated for 2 hours under reflux. The reaction product was precipitated in methanol, drawn off and then dried at 150° C. in a drying cabinet.

b)—ferrocene formation ca. 30%
by means of the Mitsunobu reaction from 3 parts of poly-[N-(4-hydroxyphenyl)-maleic imide-co-allyl trimethyl silane] and one part of ferrocenyl methanol.

The starting materials and triphenylphosphine were provided in the required stoichiometric ratio in THF and the reaction was started at room temperature by dropwise addition of the molar proportion of azodicarboxylic acid ethyl ester. After 6 hours, the ferrocene-containing polymer formed was precipitated from cyclohexane/methanol=1/1, drawn off and dried. The result was a yellow-orange powder.

3 1,2-diferrocenyl-1,2-dimethyl ethylene (Dimeric Metallocene):

0.03 mol titanium-III-chloride-THF complex was added, while stirring, with 0.03 mol LiAlH4 in 50 ml dried THF under a protective gas atmosphere and to this was added 0.01 mol acetyl ferrocene. The mixture was heated for 1 hour under reflux, cooled and filtered. The product was first eluted by column chromatography (with silica gel/toluene). The concentrated toluenic solution was precipitated in pentane and drawn off. Light yellow crystals, melting point: 210° C.-212° C., yield 40%.

4 Production of an Electrochromically Active Formulation with Polymer Metallocene

0.3 g of the polymer obtained was intensively mixed with 0.6 g of a polymer 4,4′-bipyridine and 6 g of titanium dioxide in a speed mixer at 2000 rpm for 5 minutes. 3.3 g diethylene glycol was added to this mixture. The mixture was then intensively mixed in a Speedmixer at 2000 rpm for 5 minutes.

5 Production of an Electrochromically Active Formulation with Dimer Metallocene

6 g titanium dioxide was intensively mixed with 0.6 g of polydodecylene-4,4′-bipyridine-trifluoromethyl sulphonate in a Speedmixer at 2000 rpm. 2 g diethylene glycol was added thereto and the resulting mixture intensively mixed in a Speedmixer at 2000 rpm. A light-colored formulation of paste-like consistency was obtained.

### 6 Production of an Electrochromic Cell

The paste-like formulation obtained was applied according to the prior art between mutually crossing electrodes. When a voltage was applied, a color change to blue was observed at the cathode.

An increase in the lifespan by a factor of 2 to 3 times can be achieved with these metallocene-containing cells.

What is claimed is:

1. An electrochromically active formulation based on polymer 4,4′-bipyridine structures, which are separated from one another by an alkene spacer comprising at least one of: a metallocene and a metallocene derivative.

2. The formulation according to claim 1, wherein the metallocene is iron-based.

3. The formulation according to claim 1, wherein the derivatization of the metallocene is carried out via functional groups, so that the polarity, solubility and processing ability of the metallocene derivative is improved compared with the underivatized metallocene basic structure.

4. The formulation according to claim 1, wherein at least one of the metallocene and the metallocene derivative are present as a chain polymer component in the main chain of the polymer or as a component of the side group in the polymer.

5. A method comprising the step of using an electrochromically active formulation based on polymer 4,4′-bipyridine structures, which are separated from one another by an alkene spacer comprising at least one of: a metallocene and a metallocene derivative for production of an electrochromic device.

6. The method according to claim 5, wherein the electrochromic device is a display.

7. The method according to claim 5, wherein the electrochromic device is a window or a mirror.

8. The method according to claim 5, wherein the metallocene is iron-based.

9. The method according to claim 5, wherein the derivatization of the metallocene is carried out via functional groups, so that the polarity, solubility and processing ability of the metallocene derivative is improved compared with the underivatized metallocene basic structure.

10. The method according to claim 5, wherein the metallocene and/or the metallocene derivative are present as a chain polymer component in the main chain of the polymer or as a component of the side group in the polymer.

11. A method for producing electrochromically active formulation based on polymer 4,4′-bipyridine structures, comprising the step of separating the polymer 4,4′-bipyridine structures from one another by an alkene spacer comprising at least one of: a metallocene and a metallocene derivative.

12. The method according to claim 11, wherein the metallocene is iron-based.

13. The method according to claim 11, comprising the step of carrying out the derivatization of the metallocene via functional groups, so that the polarity, solubility and processing ability of the metallocene derivative is improved compared with the underivatized metallocene basic structure.

14. The method according to claim 11, wherein the metallocene and/or the metallocene derivative are present as a chain polymer component in the main chain of the polymer or as a component of the side group in the polymer.
